(19) United States
(12) Patent Application Publication
(10) Pub. No.: US 2015/0019533 A1
(43) Pub. Date: Jan. 15, 2015

(54) SYSTEM, METHODS, & APPARATUSES FOR IMPLEMENTING AN ACCIDENT SCENE RESCUE, EXTRACTION AND INCIDENT SAFETY SOLUTION

(71) Applicants: Daniel E. B. Moody, Santa Barbara, CA (US); Christopher W. L. Wells, DOMJEAN (FR)

(72) Inventors: Daniel E. B. Moody, Santa Barbara, CA (US); Christopher W. L. Wells, DOMJEAN (FR)

(73) Assignee: STRAWBERRY MEDIA, INC., Santa Barbara, CA (US)

(21) Appl. No.: 14/331,895

(22) Filed: Jul. 15, 2014

Related U.S. Application Data
(60) Provisional application No. 61/846,220, filed on Jul. 15, 2013.

(51) Int. Cl. G06F 17/30; G06F 3/0482; G06Q 50/26; G06F 3/0484

(52) U.S. Cl. CPC G06F 17/30864; G06F 3/04842; G06F 3/0482; G06Q 50/265
USPC 707/722

(57) ABSTRACT

Described herein are methods and systems for implementing an accident scene rescue, extrication, and incident safety solution. In one embodiment, such means include receiving vehicle identification information; querying a database based at least in part on the received vehicle identification information to determine a vehicle type; retrieving associated data based on the determined vehicle type; and presenting the associated data to a user interface and causing the user interface to display at least the determined vehicle type, a navigation menu, and at least a sub-set of the associated data retrieved based on the determined vehicle type. Other related embodiments are further described.

### CLAIM OF PRIORITY

This application is related to, and claims priority to, the provisional utility application entitled “SYSTEMS, METHODS, AND APPARATUSES FOR IMPLEMENTING AN ACCIDENT SCENE RESCUE, EXTRACTION, AND INCIDENT SAFETY SOLUTION,” filed on Jul. 15, 2013, having an application number of 61/846,220 and Attorney Docket No. 9664P001Z, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments of the invention relate generally to the field of computing, and more particularly, to methods and systems for implementing an accident scene rescue, extrication, and incident safety solution.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

There are approximately 254 million cars on the road in the United States. Each year, approximately 10 million of these cars are involved in accidents and approximately, six percent of these accidents will require the use of an extrication tool. As technology has evolved, First Responders must adapt to changing on-scene circumstances. During extrication first responders risk cutting fuel lines, triggering unwanted airbag deployments and in recent years, must now perform extrication on hybrid cars having more than 700 volts of electricity flowing throughout the electrical system. If a First Responder cuts into the electrical lines of a hybrid car they may kill themselves and the passenger of the car. When a First Responder arrives on the scene of an accident, they are faced with any one of thousands of different vehicle models, each one with its own design and security features. First Responders simply do not have time to read every instruction manual that directs the varied passenger extrication processes from a diverse market of vehicles. Consequently, firefighters must balance the time-sensitive nature of extrication with limited knowledge of a particular vehicle model very often requiring they assess where to cut into a car during the extrication process thus endangering their own lives and the lives of the passengers.

The present state of the art may therefore benefit from the methods and systems for implementing an accident scene rescue, extrication, and incident safety solution as are taught herein.

### BRIEF DESCRIPTION OF THE DRAWINGS

Embodiments are illustrated by way of example, and not by way of limitation, and can be more fully understood with reference to the following detailed description when considered in connection with the Diagrams, Figures, and Appendices in which:

FIG. 1 depicts an exemplary architecture in accordance with described embodiments;

FIG. 2 depicts an alternative exemplary architecture in accordance with described embodiments;

FIG. 3 depicts a series of layered images utilized in conjunction with described embodiments;

FIG. 4 is a flow diagram illustrating a method for implementing an accident scene rescue, extrication, and incident safety solution in accordance with disclosed embodiments;

FIG. 5 shows a diagrammatic representation of a computing device within which embodiments may operate, be installed, integrated, or configured;

FIG. 6 depicts an exemplary graphical interface operating at a mobile, smartphone, or tablet computing device in accordance with the embodiments;

FIG. 7A depicts a tablet computing device and a hand-held smartphone each having a circuitry integrated therein as described in accordance with the embodiments;

FIG. 7B is a block diagram of an embodiment of tablet computing device, a smart phone, or other mobile device in which touchscreen interface connectors are used; and

FIG. 8 illustrates a diagrammatic representation of a machine in the exemplary form of a computer system, in accordance with one embodiment.

### DETAILED DESCRIPTION

Described herein are methods and systems for implementing an accident scene rescue, extrication, and incident safety solution. In one embodiment, such means include receiving vehicle identification information; querying a database based at least in part on the received vehicle identification information to determine a vehicle type; retrieving associated data based on the determined vehicle type; and presenting the associated data to a user interface and causing the user interface to display at least the determined vehicle type, a navigation menu, and at least a sub-set of the associated data retrieved based on the determined vehicle type.

In the following description, numerous specific details are set forth such as examples of specific systems, languages, components, etc., in order to provide a thorough understanding of the various embodiments. It will be apparent, however, to one skilled in the art that these specific details need not be employed to practice the embodiments disclosed herein. In other instances, well known materials or methods have not been described in detail in order to avoid unnecessarily obscuring the disclosed embodiments.

In addition to various hardware components depicted in the figures and described herein, embodiments further include various operations which are described below. The operations described in accordance with such embodiments may be performed by hardware components or may be embodied in machine-executable instructions, which may be used to cause a general-purpose or special-purpose processor programmed with the instructions to perform the operations. Alternatively, the operations may be performed by a combination of hardware and software.

Embodiments also relate to an apparatus for performing the operations disclosed herein. This apparatus may be specially constructed for the required purposes, or it may be a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, embodiments are not described with reference to any particular programming language. It will be appreciated that a variety of programming languages may be used to implement the teachings of the embodiments as described herein.

Embodiments may be provided as a computer program product, or software, that may include a non-transitory machine-readable medium having instructions stored thereon, which may be used to program a computer system (or other electronic devices) to perform a process according to the disclosed embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical), etc.

Any of the disclosed embodiments may be used alone or together with one another in any combination. Although various embodiments may have been partially motivated by deficiencies with conventional techniques and approaches, some of which are described or alluded to within the specification, the embodiments need not necessarily address or solve any of these deficiencies, but rather, may address only some of the deficiencies, address none of the deficiencies, or be directed toward different deficiencies and problems where are not directly discussed.

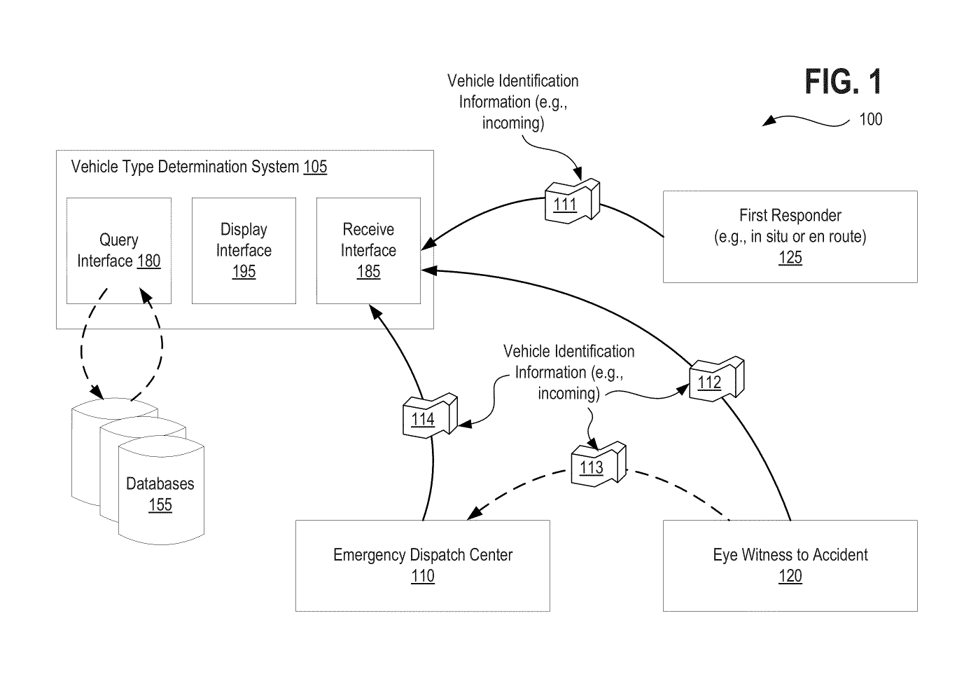

FIG. 1 depicts an exemplary architecture 100 in accordance with described embodiments. In particular, there is depicted a vehicle type determination system 105 which is communicatively interfaced with databases 155 via query interface 180. The vehicle determination system additionally includes a display interface 195 for presenting a user interface or a GUI to a user device and a receive interface 185 to receive vehicle identification information from any of a number of varying sources.

For instance, as depicted here, there is an eye witness to an accident 120 capable to observe, record, witness, or otherwise collect vehicle identification information 112 which may then be passed to the receive interface 185 directly, such as via radio or telephone to a person with an available device, such as a police officer or by entering the data at an available device, such as a police officer or paramedic arriving on scene before first responders capable of vehicle extrication, but nevertheless having access to a user interface within which to enter the observed vehicle identification information. Alternatively, an eye witness to an accident 120 may pass vehicle identification information 113 to an emergency dispatch center 110 which then in turn enters the vehicle identification information 113 into an appropriate user interface, for instance, at an emergency dispatch terminal, and then passes the vehicle identification information 114 to the receive interface 185 of the vehicle type determination system 105. In another embodiment, a first responder 125 either en route (e.g., receiving non-entered vehicle identification information through dispatch) or in situ observing a wrecked vehicle may observe and enter vehicle identification information 111 into an appropriate user interface which is then passed to the receive interface 185 of the vehicle type determination system 105.

Problematically, conventional solutions simply fail to provide adequate information about vehicles which becomes a serious problem for first responders arriving on scene and having to address the myriad of differing kinds of safety devices which may pose a serious risk of injury or death during a passenger's extrication from a wrecked vehicle.

Moreover, the kind of information for a vehicle that is available to the public utilizes a different taxonomy, nomenclature, and organizational method than what is utilized by the vehicle manufacturers themselves. This difference causes further problems in identifying a particular vehicle type so as to retrieve and assess appropriate accident scene rescue, extrication, and incident safety solutions. Consider for example that manufacturer BMW sells a “Series 3” and a “Series 5” vehicle, but internally, BMW identifies these vehicles as sometimes “e42” or “e43,” which causes the identification of a vehicle type to be complicated as first responders are not familiar with these internal manufacturing codes, yet, many manufacturers arrange their rescue and extrication guidelines by these internal codes rather than more widely understood nomenclature utilized in the public space. Other kinds of information are known to mechanics and may yet be organized by different vehicle type codes than the public nomenclature or the vehicle manufacture's codes. Regardless, it is important to be able to retrieve such information, for instance, illustrating how to shut off a fuel line or how to disconnect a hybrid vehicle's high voltage battery. Because of the varying vehicle taxonomies, first responders may not be able to retrieve the needed information simply by a vehicle's badge, such as BMW Series 3, or Honda Accord, etc.

Still further, it will readily be appreciated that a badly wrecked automobile simply does not look the same as in its pre-accident condition. Vehicles can be badly smashed, distorted, and even torn apart during a violent accident which further complicates appropriate determination of a vehicle type.

Some helpful information is available to fire fighters and other first responders according to Vehicle Identification Numbers (VINs), but VINs are problematic because they utilize a 17 character alphanumeric sequence which is very often hidden in obscure places on a vehicle, which in turn causes problems of incorrect reading, transcription, and entry of a vehicle's VIN and also the problem of even seeing a VIN on a wrecked vehicle. For instance, VINs are conventionally provided at the base of a windshield, but may be hidden from view by a smashed windshield or may have been physically obscured from view due to the damage and physical compression or movement of a vehicle's structure during an accident. Other vehicle manufactures are now promoting the use of QR codes, however, such codes are on very few vehicles and will not likely be retrofitted onto the millions of vehicles already on the public roads today.

The dangers of accident scene rescue, extrication, and incident safety solutions cannot be understated. Different vehicles have hazards in different places and the risk is non-trivial. For instance, a seatbelt tensioner is very dangerous to both passenger and rescuer alike in a post accident condition, as is a gas generator for an airbag which may trigger and explode and injure or the passenger or the rescuer. Similarly, new electric systems of high voltage hybrid vehicles are dangerous if the wrong wire is cut at the wrong time, potentially causing electrocution. Further still, these hazard conditions are not standardized and may thus be located in different places for different cars, even in different places for vehicles from the same vehicle manufacturer. Counter intuitively, as automobiles have gotten safer for the unexpected accident condition, they have simultaneously become more dangerous in the post accident environment, in which the airbags may explode, seatbelt tensioners may retract the seatbelt violently, and high voltage lines that provide green energy for the vehicle can lethally electrocute an unwitting passenger or rescuer.

Other hazards are present which can inhibit expeditious and safe extrication of a passenger, such as high tension steel pillars which provide excellent passenger safety during an accident but also are highly resistant to even industrialized cutting and extrication means, and thus, must be avoided for safe passenger extrication. However, first responders cannot simply differentiate between regular steel and high tension steel by looking at it. Failure to understand a non-cut point for vehicle extrication may waste time and place injured victims at risk.

Non-intuitive risks are present as well, such as bumper and hood shocks which may explode violently when heated, such as by a vehicle gasoline fire or even become dangerous projectiles when they burst. Fuel pumps provide yet another risk for a damaged vehicle as they may not be shut off predictably and may quite literally fuel a fire or a fire risk.

It is not practical for first responders to memorize every possible permutation of vehicle hazards, and thus, improved information retrieval means such as those described herein can better facilitate their efforts in conducting safer and more expeditious accident scene rescue, extrication, and incident safety solutions.

The query interface 180 of the vehicle type determination system 105 enables search by any of a variety of methods, with appropriate user interfaces being presented at a compatible device via the display interface 195. For instance, it is possible to search for the appropriate vehicle type by license plate number which may or may not additionally include licensing authority information, such as a state, country, province, etc., or search may be conducted by a VIN number, or search may be conducted using free text, wild-carding (e.g., a portion but not all of a VIN or license plate, or missing licensing authority data, etc.), or search may be conducted through a gallery style search, such as selecting fuel type and trim level, or vehicle make and model, or vehicle style (e.g., coupe, van, etc.) and doors, and then corresponding images, etc. Regardless, the vehicle identification information received from the varying sources described enable the query interface to search for and identify the appropriate vehicle type. Using the identified or determined vehicle type, additional associated information may then be retrieved for presentment to a user via the display interface 195 to aid in the accident scene rescue, extrication, and incident safety solution.

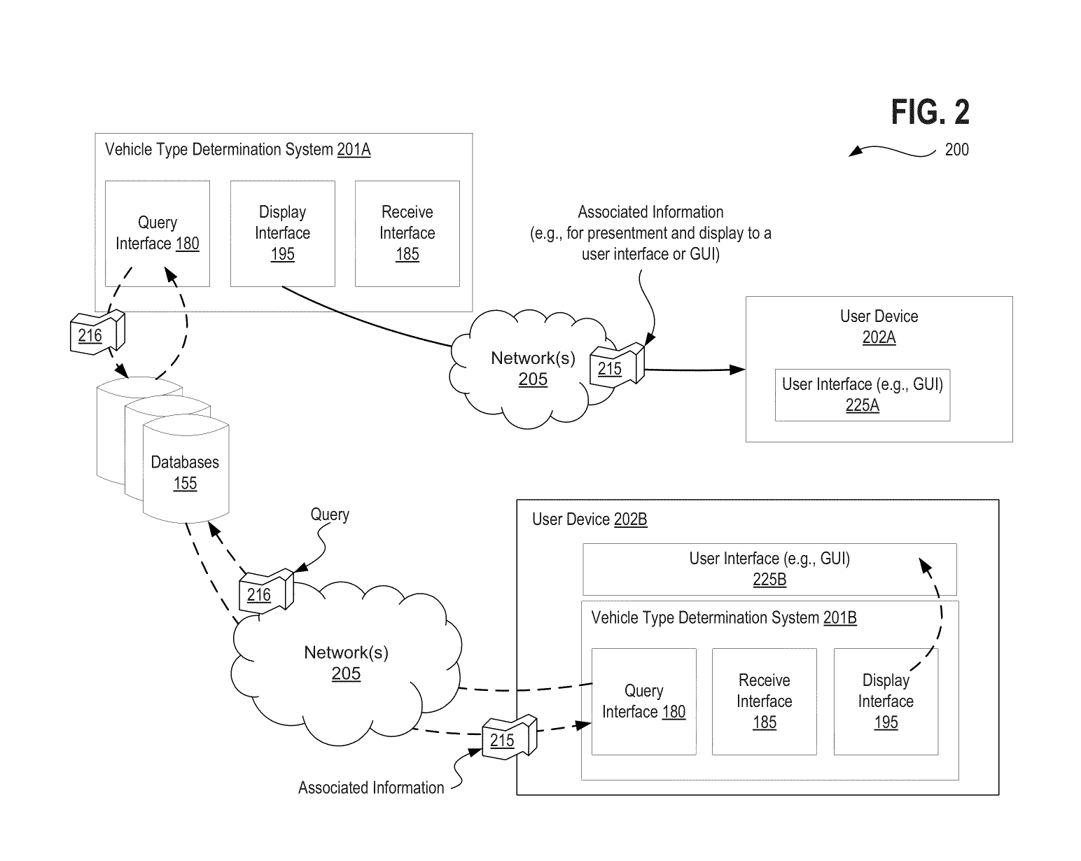

FIG. 2 depicts an alternative exemplary architecture 200 in accordance with described embodiments. The databases 155 are again depicted here, however, the vehicle type determination system is now depicted in varying forms and embodiments. On the upper left is a vehicle type determination system 201A which includes therein a query interface 180 capable of querying (e.g., via query 216) databases 155 either remotely or locally, over a network (e.g., a LAN, VPN, Internet, WAN, etc.). Further depicted is the receive interface 185 and a display interface. Shown here is display interface 195 of vehicle type determination system 201A sending associated information 215 (e.g., additional information for presentment and display at a user interface or GUI) to a user device 202A via network(s) 205. Such additional information may then be displayed or presented at user interface 225A of user device 202A. As depicted, user device 202A may operate remotely from the vehicle type determination system 201A which may reside as an application at a hosted computing environment, such as a SaaS (Software as a Service) implementation which provides cloud computing services or software on-demand without requiring the user device 202A to execute the application locally, instead simply accessing the resources of the vehicle type determination system 201A remotely and rendering locally the information for display at the user interface 225A.

Alternatively, as depicted on the bottom portion is user device 202B having embodied therein vehicle type determination system 201B which again includes query interface 180, receive interface 185, and display interface 195. Query interface 180 of user device 202B is capable of querying (e.g., via query 216) the databases 155 which are depicted as residing remotely from the user device 202B. The databases 155 again return the associated information 215 to the query interface of user device 202B. The associated information 215 returned may then be presented or caused to be displayed by the display interface 195 to the user interface 225B (e.g., GUI) of the user device 202B. Unlike user device 202A, the user device 202B may execute an application locally capable of carrying out the methodologies described and access database resources remotely. Other combinations are also feasible, such as having some data stores and database resources (e.g., such as a VIN to vehicle type mapping database) residing locally at the vehicle type determination system 201A or 201B and other databases (e.g., such as a license plate look up system) reside remotely and simply be made accessible via a network 205 as depicted.

The associated information 215 returned provides not merely extrication information but may provide a wide range of information correlated to and retrievable with the determined vehicle type as identified pursuant to the various search methodologies described. For instance, associated information 215 may describe how the vehicle components work, describe repair information, or may provide a large group of structured information which is then provided through a filterable view so that the most desirable information to a given user may be selected and viewed at the user interface 225A-B.

Take for example a fire fighter in the role of a first responder utilizing the user interface 225A-B. After opening and authenticating through the user interface 225A-B, if appropriate, the user may be presented with a search context at the user interface 225A-B, through which the user may enter license plate and state information, or other licensing authority, and submit the search, responsive to which the receive information would accept the input, query a first database to correlate the license plate information to a VIN number or a VIN number range, return the VIN or VIN range, and then the query interface 180 would query a second database using the VIN number information for a vehicle type. Once the vehicle type is determined, a third database, or additional databases and data stores may then be queried to retrieved the associated information 215 for display to the user via the user interface 225A-B via the display interface 195 means of the vehicle type determination systems 201A-B depicted.

The license plate search capability may take the form of a text entry having a corresponding and restricted data mask, or may be a free form text entry which permits wild-carding and potentially errors to be handled by the vehicle type determination system 201A-B or may constitute an image capture device, such as a smart phone or tablet capable of taking a picture of a physical license plate, extracting the license plate's alphanumeric string and licensing authority, and then applying the abstracted data from the picture or license plate image to the search interface to proceed as above just as if text had been entered.

If the license plate search fails, then an alternative but less preferred means is to search by VIN, however, first responders are far less likely to have access to a correct VIN number before arriving on scene as eye witnesses, police, ambulance personnel, etc., are very likely to understand the need to provide a license plate number, but far less likely to understand the need or even be capable of correctly ascertaining a 17 digit VIN by which to identify the vehicle. Nevertheless, the search means are provided in the event that a VIN is obtained or the license plate search fails to identify the corresponding vehicle type which relies upon accurate information in the resource databases being transacted with over the networks 205 as described.

Having entered the license plate information or VIN information and performed the search as described, the user interface 225A-B may, by default, display the vehicle type information and a summary of the vehicle with key data for quick reference, along with a navigation menu through which the first responder or other user may then self navigate to the appropriate resources needed for the situation at hand, be it accident scene rescue and extrication, research, training, etc. As alluded to previously, search does not necessarily require VIN or license plate information, but rather, may be conducted via a gallery search with a variety of starting criteria, which build to narrow down upon the appropriate vehicle type determination. For instance, a gallery search may begin with the manufacturer, such as Nissan, Toyota, Ford, etc., which then displays a sub-set gallery selection interface for vehicle types not yet ruled out. For instance, selecting Ford would rule out all manufacture types not corresponding to Ford. Alternatively, gallery search may begin with a year, or a body type (e.g., wagon, coupe, truck, minivan, etc), or a fuel type (e.g., electric, diesel, gas, etc.), or a trim level, or a model type, etc., and is selectable by the user. For example, if the vehicle has a trim level badge such as LX, EXL, or DX, etc., then the search could be conducted accordingly, even without the user knowing the year, make, model, or other typical identification information. Or if the user wishes to select hybrid vehicles, or electric vehicles, then again, a gallery search selection may be instituted accordingly, which will then present an appropriate sub-set for all vehicle model types not yet ruled out.

Alternatively, the user may use free form search or wild-carding. For instance, wild carding may prove helpful where partial but incomplete license plate information is known or a partial but incomplete VIN is known. Free form search may be utilized, where the user simply enters free form text for search, such as “Ford hybrid DX” which would then render the appropriate results for identification and selection by the user. The search may, if necessary, return sub-groups such as vehicle years 1967-1989, 1990-2001, 2002-2011, and 2012-2014, from which the user may then further narrow the vehicle until a determined vehicle type is reached.

Freeform search and gallery search may prove especially useful in training scenarios where the user is researching but would not have actual license plate data or VIN data, as such information would only be available during an accident scene rescue and may not be pertinent for training purposes.

Embodiments that provide default summary information may present an image or likeness of the determined vehicle type along with key features of the vehicle such as break resistant glass, high tension steel pillars and locations, fuel types, battery type and chemistry, electric voltages and line locations, air bags, second row and passenger air bags, and so forth.

Associated information 215 retrieved and displayed may include more than merely the determined vehicle type, navigation menu, and summary information according to the various embodiments. For instance, though not necessarily displayed immediately, associated information 215 may include much more detailed information about vehicle features.

Searching by license plate may provide a preference in geographical context, to identify first the most probable vehicles in a given state, region, country, etc., so as to improve data results. Results may then be complementary or contradictory from which probability may be applied or multiple options may be presented to the user for selection and verification. License plate searching may be provided through a third party service provider and conducted through an Internet based web API through which queries are submitted and results are returned. The results returned may be a VIN number specific to the corresponding vehicle through which subsequent query utilizing the specific VIN can then be used to map or correlate the VIN number to the appropriate vehicle type determination or the license plate search may return a VIN number range. For instance, rather than having every feasible VIN number for every known vehicle, it may be that the license plate query interface provider returns a range of VINs within which the license plate resides. In such a case, it may be that a second database which correlates VIN numbers to vehicle type determination requires the specification of a particular VIN and not a VIN number range, in which case, a synthesized VIN is rendered based on the range, in which the synthesized VIN is compatible with the appropriate VIN number format and complies with a VIN that could be within the range, subsequent to which the synthesized VIN is then submitted as a query to an appropriate database to map or return the vehicle type determination. For example, a synthesized VIN that is compatible with a VIN mask may take the form of the portions of the VIN that are known and unique based on the VIN range that is returned and then randomly selecting, or taking the average, or the median, or the first or the last number sequence or alphanumeric sequence which conforms to the appropriate VIN data mask as well as falls within the VIN range returned and as such, represents a plausible VIN from the returned VIN range even if the VIN does not necessarily correlate (and most probably will not correlate) to the unique vehicle in question for which the license plate data is known. Because the determined vehicle type is being sought and not a unique vehicle identification, it is acceptable to synthesize the VIN in such a way for further database queries, whereas such means would likely not be acceptable in other contexts, such as for an insurance company attempting to underwrite coverage on a specific vehicle.

With the determined vehicle type, yet another database 155 or data store may be referenced, or multiple such resources may be utilized. For instance, a database of mechanics' repair information may be accessed based on vehicle type or a correlated vehicle ID for that particular database, from which information returned may include, for instance, how to change a door handle to how to disconnect a fuel line or a high voltage battery. Some of the information may thus be relevant whereas other information is not. The information may then be presented in differing views, such as a curated view in which the deemed relevant information is presented first or a filterable view in which all information is presented and the user is enabled to sift or filter through the data to identify the appropriate resource or information within a larger mixed data set. For instance, other data returned from such a database may be recall notices, engine codes, repair time allotments, service procedures, part codes, schematics, vehicle photographs, etc. The filterable view may thus present the information without bias, whereas the curated view provides with priority, or possibly only provides, information about, for example, locks, sealed spaces, fuel lines, high voltage electrics, reinforced door beams, break resistant glass, etc.

Such information is not necessarily provided by so called rescue cards issued from vehicle manufacturers. For instance, it may be that a rescue car illustrates an extrication requiring separation of a door or cutting of high voltage lines in a given sequence, both of which effectively destroy the car and take additional time, whereas service mechanics may know through appropriate databases that disengaging a child's lock or removal of a fuse may provide the desired result for the purposes of extrication as well as service, may also be faster, and will not destroy a vehicle. Consider for example a child locked alone in a car in which case there is no accident or wrecked car, per se, yet extrication is still required. Obviously the child's safety is paramount, however, safe extrication without necessitating the destruction of a vehicle may nevertheless be an appropriate goal where feasible.

Additional information that may be retrievable through such databases are manufacturing codes which may then be utilized as search keys for other databases to obtain still richer data for presentment to the user interface 225A-B.

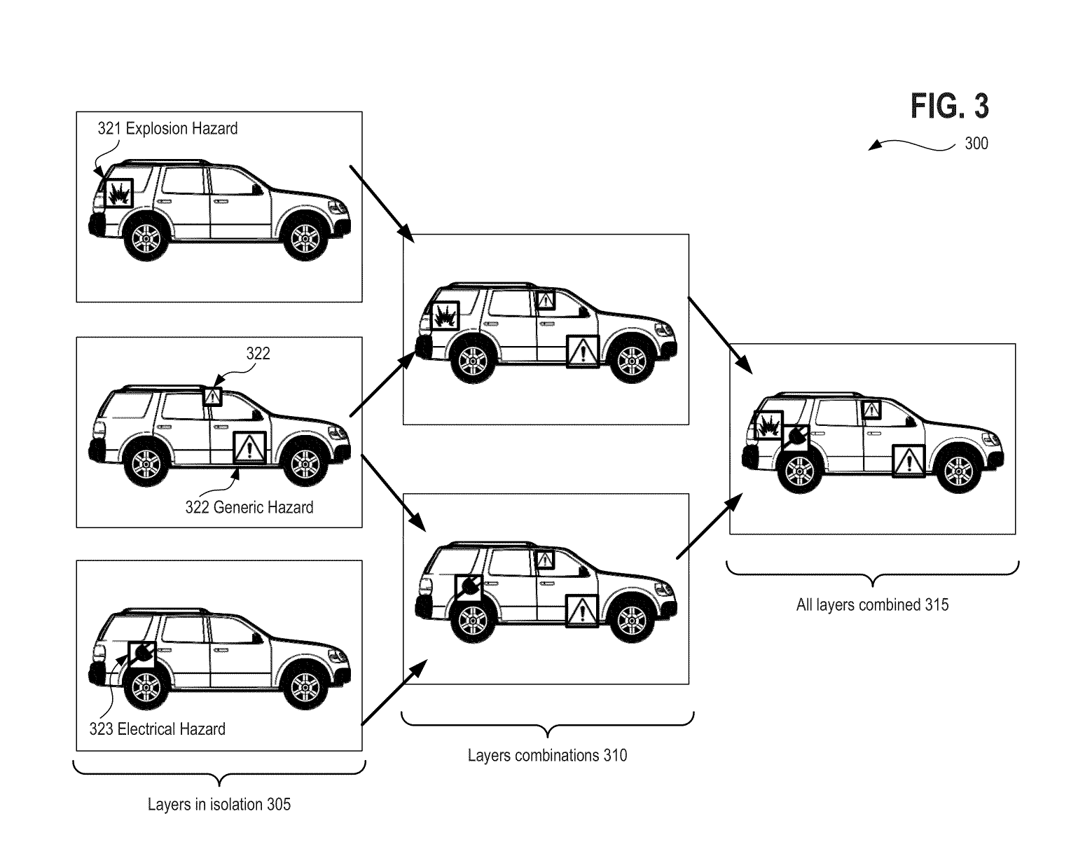

FIG. 3 depicts a series 300 of layered images utilized in conjunction with described embodiments. For instance, depicted here are layers in isolation 305, different layer combinations 310, and all layers combined 315. There may be many more than three distinct layers for any given determined vehicle type, however, the three isolated layers, foils, or laminars that are depicted here are merely exemplary. As can be seen on the left, the top one of the layers in isolation 305 depicts a fire or explosion hazard 321, such as a fuel tank or trunk shocks. The next layer down depicts a generic hazard 322, perhaps a high tension steel door pillar or an airbag. The next layer down on the bottom of the three layers in isolation 305 depicts an electrical hazard 323, such as a high voltage line or a high voltage motor located at or near each of the vehicles wheels. Any of a variety of hazards may be depicted in such a way. Moving from left to center, it can be seen that there are different layer combinations 310, in which the top and middle left most layers are combined showing now a single vehicle but with combined hazards including the explosion hazard and the generic hazard. At the bottom of the layers combinations 310 a different combination is provided which results from the left most bottom and left most middle layers being combined to now show an electrics hazard along with the generic hazard. Finally, at the rightmost side, all layers combined 315 are depicted in which the explosion hazard 321, the electrics hazard 323, and the generic hazard 322 are all depicted together within a single foil, layer, or laminar.

According to certain embodiments, the images within the layers may be merely an outline with various internal features and hazards displayed throughout multiple ones of the layers in a series of layers. Each of the layers may be isolated or aggregated by the end user through the navigation and user interface. The types of layers may be similar to the categories provided with vehicle components display context, such as schematics, including depicting a similar vehicle outline, vehicle internal or interior details, seats layer, hazard layer information, electrical, fuel system, etc., each depicted using icons or keys to show factual information about what and where the various hazardous features are located within the determined vehicle type.

The layers may correspond to a rescue card format which is optimized for viewing online and navigating via user events, clicks, presses, swipes, etc., through to the various elements of the determined vehicle type, layer by layer to build up into an aggregate view or to peel back the particular elements that the user wishes to view or hide.

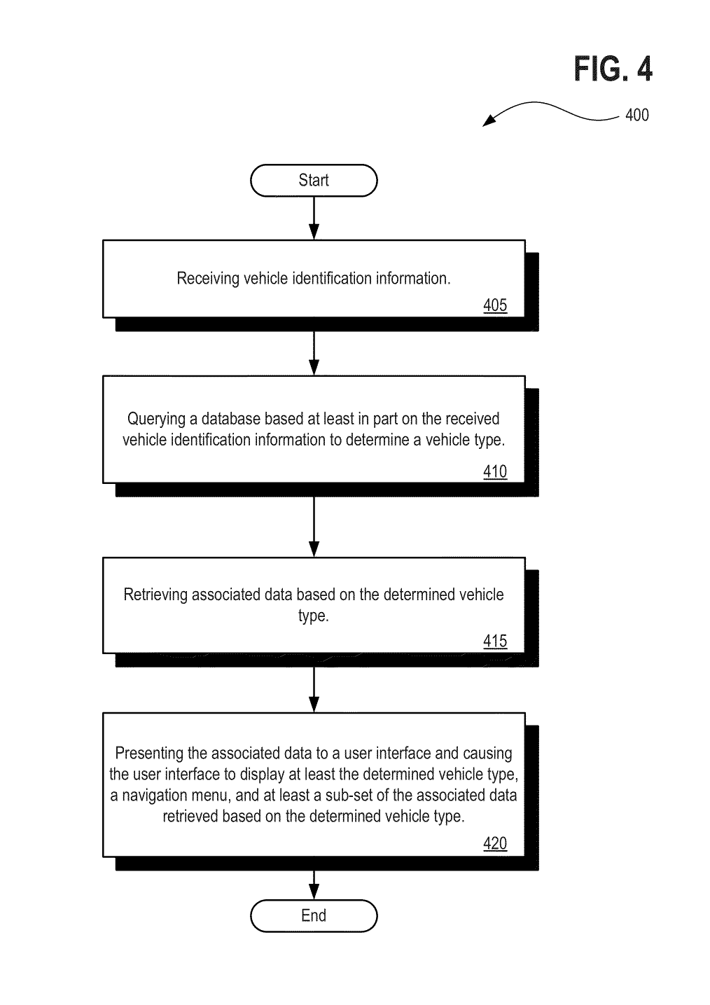

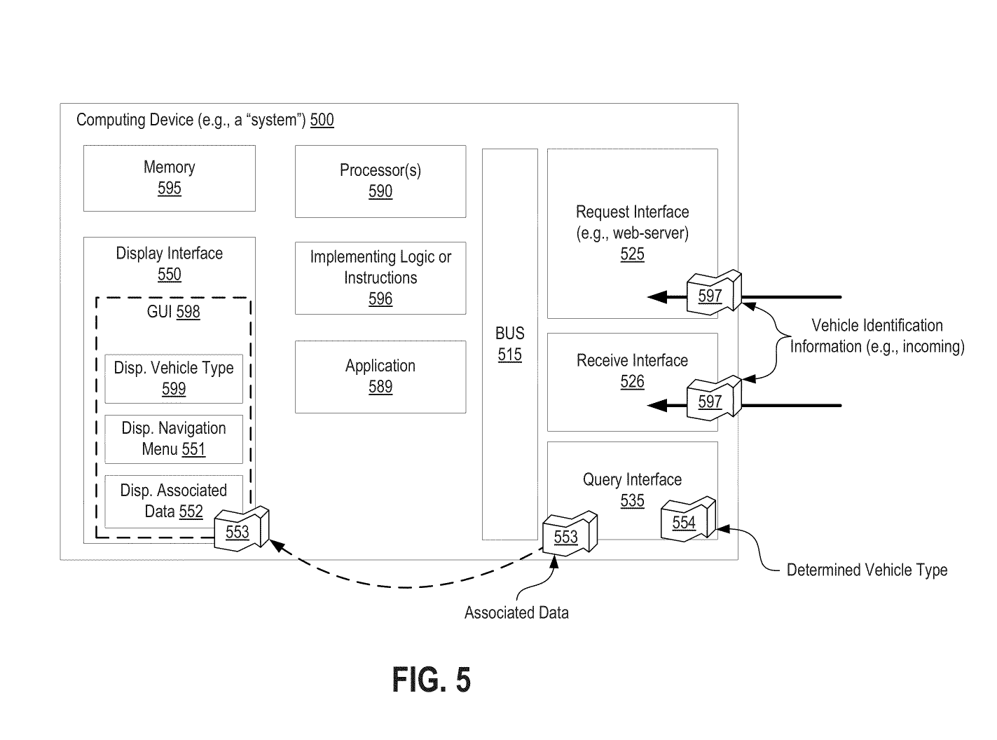

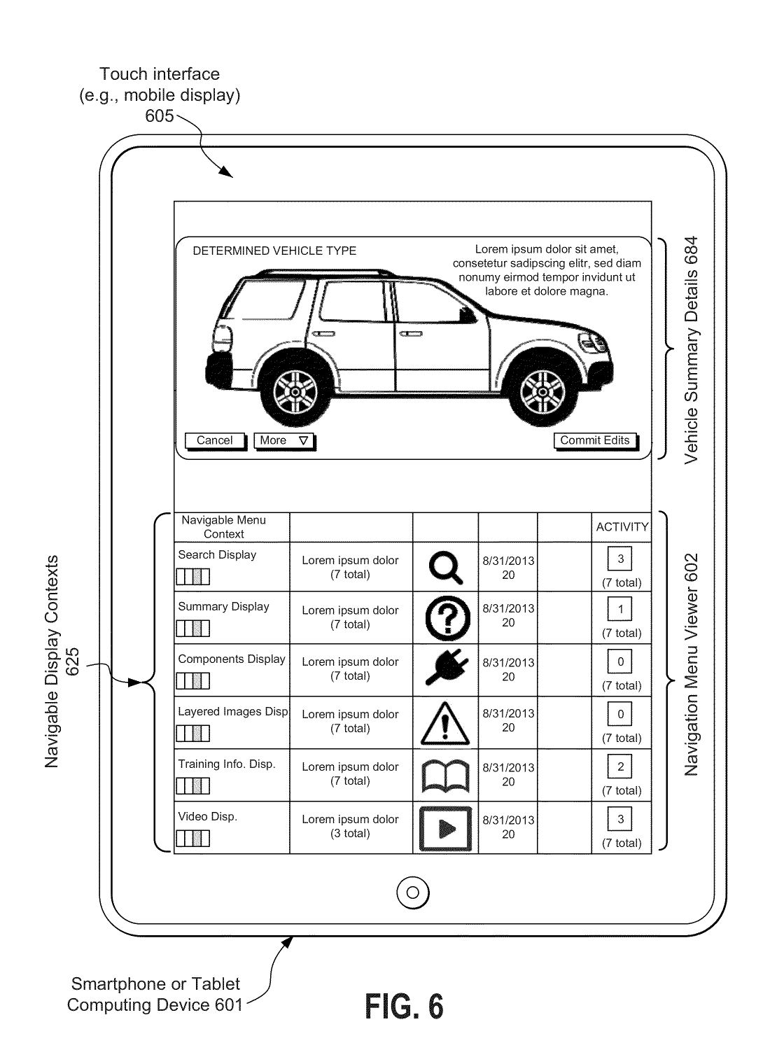

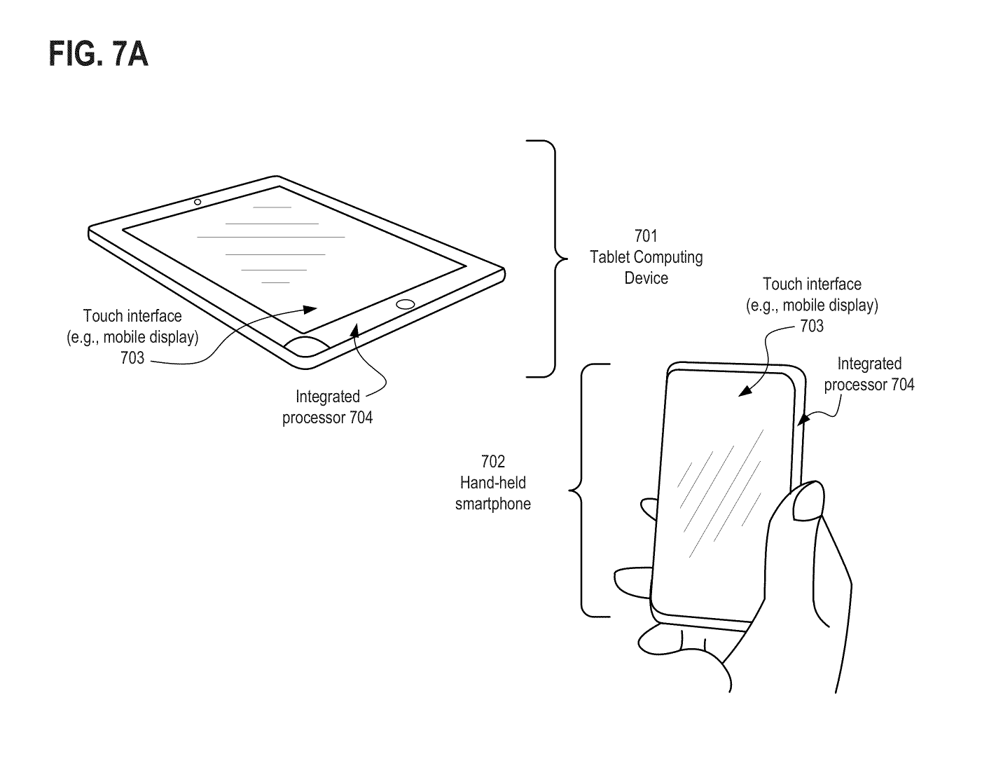

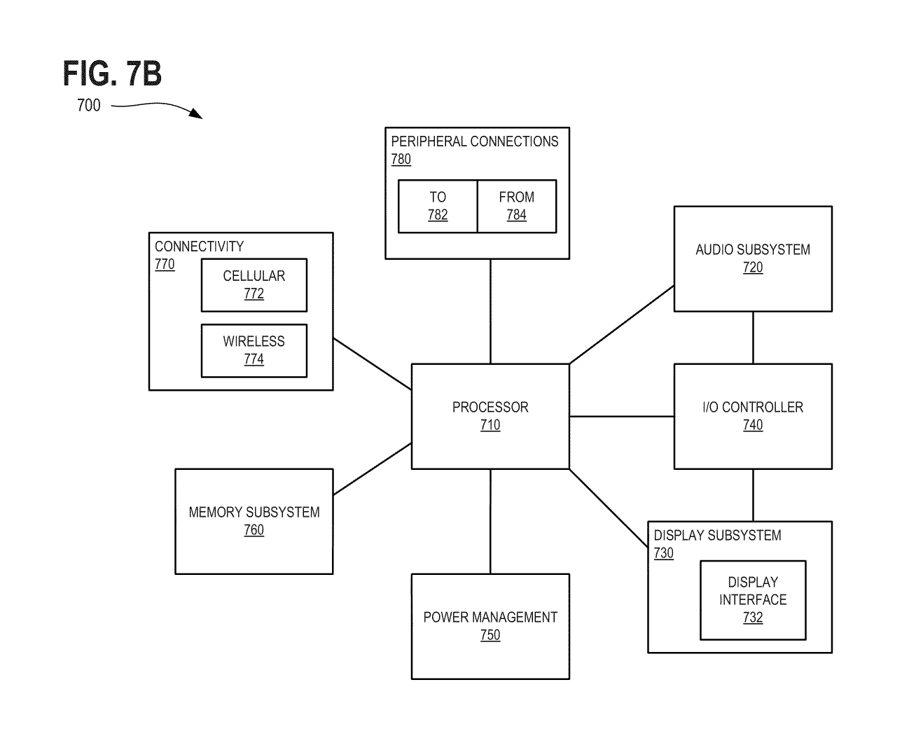

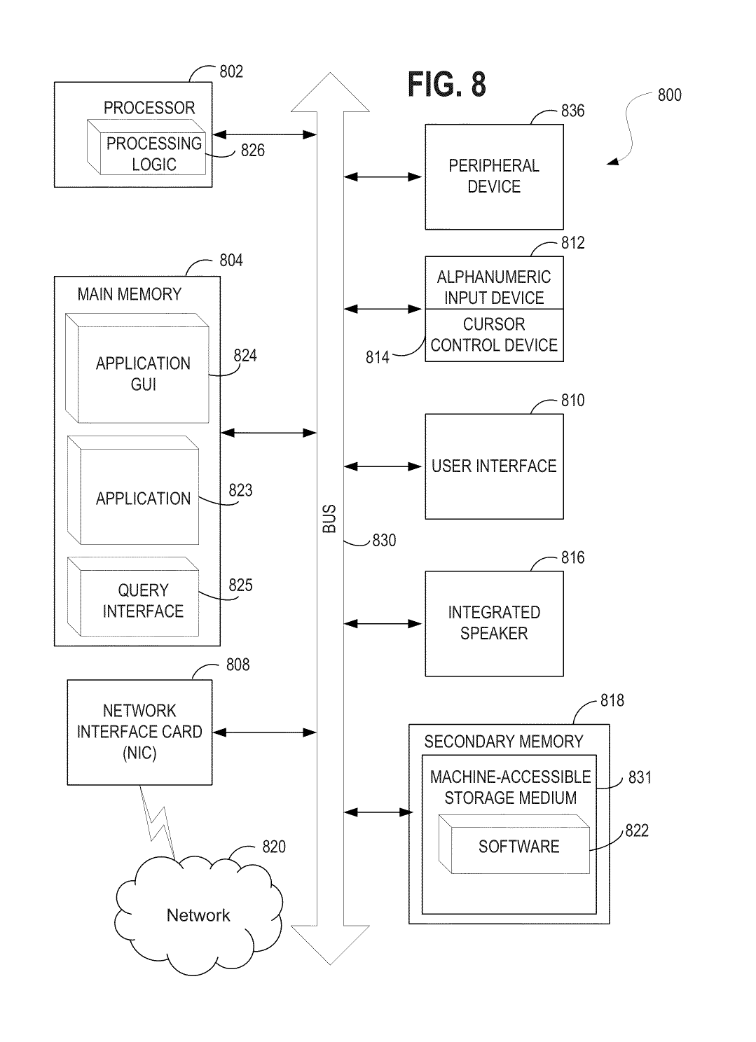

FIG. 4 is a flow diagram illustrating a method 400 for implementing an accident scene rescue, extrication, and incident safety solution in accordance with disclosed embodiments. Method 400 may be performed by processing logic that may include hardware (e.g., circuitry, dedicated logic, programmable logic, microcode, etc.), software (e.g., instructions run on a processing device to perform various operations such as receiving, querying, retrieving, record retrieval, presenting, displaying, determining, analyzing, processing transactions, executing, providing, linking, mapping, communicating, updating, transmitting, sending, returning, etc., in pursuance of the systems, apparatuses, and methods, as described herein. For example, the vehicle type determination system 105 as depicted at FIG. 1, the computing device (e.g., a “system”) 500 as depicted at FIG. 5, the smartphone or tablet computing device 601 at FIG. 6, the hand-held smartphone 702 or mobile tablet computing device 701 depicted at FIG. 7A, or the machine 800 as depicted at FIG. 8, may implement the described methodologies. Some of the blocks and/or operations listed below are optional in accordance with certain embodiments. The numbering of the blocks presented is for the sake of clarity and is not intended to prescribe an order of operations in which the various blocks must occur.

At block 405, processing logic receives vehicle identification information.

At block 410, processing logic queries a database based at least in part on the received vehicle identification information to determine a vehicle type.

At block 415, processing logic retrieves associated data based on the determined vehicle type.

At block 420, processing logic presents the associated data to a user interface and causing the user interface to display at least the determined vehicle type, a navigation menu, and at least a sub-set of the associated data retrieved based on the determined vehicle type.

According to another embodiment of method 400, receiving the vehicle identification information includes one of: receiving the vehicle identification information from a police, fire, and/or emergency dispatch center (“dispatch”), in which the dispatch receives the vehicle identification information via radio or telephone and enters the vehicle identification information into a dispatch computer terminal for transmission to the system, the system receiving the vehicle information from the dispatch computer terminal; receiving the vehicle identification information via a first responder's in situ computing device en route to an accident scene; receiving the vehicle identification information via a mobile computing device, tablet, smart phone, or laptop computer having the user interface displayed thereupon, in which the mobile computing device, tablet, smart phone, or laptop computer receives the vehicle identification information as a user input and transmits the vehicle identification information to the system for use in querying the database; and receiving the vehicle identification information from a first computing device, communicating the vehicle identification information to the system over a network, and communicating the associated data for presentment to the user interface to a third computing device over the network.

According to another embodiment of method 400, receiving the vehicle identification information includes receiving license plate and licensing authority data as the vehicle identification information; in which the method further includes querying a second database, distinct from the first database, in which querying the second database includes specifying the license plate and licensing authority data as part of a search query to the second database and receiving a Vehicle Identification Number (VIN) or a VIN range responsive to the querying of the second database; and in which querying the first database based at least in part on the received vehicle identification information to determine a vehicle type includes querying the first database based at least in part on the received VIN or the VIN range received from the second database.

According to another embodiment of method 400, the second database includes a third party database operating as a cloud based service and accessible to the system over a public Internet network; in which the first database includes a locally connected database accessible to the system via a Local Area Network; in which receiving the vehicle identification information includes receiving an alphanumeric string corresponding to an automobile license plate and licensing authority; in which querying the second database includes querying the third party database operating as the cloud based service via an Application Programming Interface (API) into which the alphanumeric string corresponding to the automobile license plate and licensing authority is entered as input; in which querying the database based at least in part on the received vehicle identification information includes specifying the alphanumeric string corresponding to the automobile license plate and licensing authority as an input into the API and receiving the VIN or VIN range in return; and in which querying the first database includes querying the locally connected database specifying the VIN or a VIN compatible string derived from the VIN or VIN range to determine the vehicle type.

According to another embodiment of method 400, querying the first database based at least in part on the received VIN or the VIN range received from the second database includes: querying the second database specifying the received VIN when the VIN is received and querying the second database specifying a synthesized VIN when the VIN range is received; receiving the vehicle type responsive to querying the second database; and in which the synthesized VIN includes an individual VIN compatible string derived from the VIN range, in which the VIN range corresponds to a plurality of theoretical individual VINs and is incompatible with a standardized VIN format.

According to another embodiment the method 400 further includes: querying a third database, distinct from the first and second databases; in which querying the third database includes specifying the determined vehicle type; and receiving the associated data from the third database responsive to querying the third database.

According to another embodiment of method 400, receiving the vehicle identification information includes one of: receiving a Vehicle Identification Number (VIN); receiving an alphanumeric string corresponding to a vehicle license plate string and associated state, province, or country having licensing authority for the license plate string; receiving an image of the vehicle license plate and extracting the alphanumeric string corresponding to the vehicle license plate from the image; receiving a partial vehicle license plate and wildcarding a missing portion of the partial vehicle license plate; receiving a search string having therein free form text or key word search text; and receiving user input at the user interface specifying the vehicle identification information from a graphical gallery view of available vehicle types.

According to another embodiment of method 400, the determined vehicle type includes a unique vehicle identifier (vehicle ID), the unique vehicle ID corresponding to at least a year, make, and model, and optionally specifying one or more of manufacturer vehicle code, chassis code, fuel type, trim level, engine type, and drive train.

According to another embodiment of method 400, retrieving the associated includes receiving, based on the determined vehicle type, one or more of: vehicle rescue cards; vehicle Frequently Asked Questions (FAQs); vehicle foils, layers, and/or laminar images, each depicting vehicle components; vehicle hazard layers; vehicle video demonstrations; vehicle rescue training information; vehicle safety data; vehicle telemetry data; vehicle web forum data; vehicle schematics; vehicle parts lists; vehicle photographs; vehicle diagrams; vehicle cut points and non-cut points for emergency passenger extrication from a wrecked vehicle; and vehicle de-electrification instructions for a hybrid electric vehicle and non-cut points specific to the hybrid electric vehicle.

According to another embodiment of method 400, presenting the associated data to a user interface includes presenting the associated data to a Graphical User Interface (GUI) at a client device communicably interfaced to the system, in which presenting to the GUI includes presenting a graphical navigational menu at the GUI of the client device and presenting a summary based on the determined vehicle type to the GUI, the summary having been retrieved as the sub-portion of the associated data retrieved.

According to another embodiment of method 400, presenting the associated data to a user interface includes presenting a summary of vehicle key rescue details based on the associated data retrieved, the summary of vehicle key rescue details including on a single screen of the user interface a one or more of: engine type, quantity of airbags, types of airbags, locations of airbags, fuel shut off device location, fuel capacity, break resistant glass locations, quantity of batteries and battery types, battery voltages, battery chemistry, quantity of restraints and restraint types, and cut resistant door beams and locations.

According to another embodiment the method 400 further includes: receiving user input at the GUI responsive to a user initiated event at the graphical navigational menu and responsively navigating the GUI to a new graphical context based on the user input, and presenting at the GUI a different sub-portion of the associated data retrieved based on the new graphical context navigated to based on the user input.

According to another embodiment of method 400, the navigation menu includes a graphical navigational menu displayed within a Graphical User Interface, the graphical navigational menu having navigational elements including at least two or more of: a search context; a summary context; a components context; a layered images context; a Frequently Asked Question(s) context; a service and safety precautions context; a video context; a training context; a community context; and an accident information context.

According to another embodiment of method 400, the search context provides a search interface through which to input any of a license plate, a VIN, a free form text or search parameter inquiry, or gallery input search; in which the summary context provides summary information as a default single screen at a Graphical User Interface (GUI) responsive to a successful search result input to the search context; in which the components context provides additional detailed information about the determined vehicle type in a filterable view; in which the layered images context provides images and diagrams of the determined vehicle type including internal features and hazard features on a plurality of distinct image layers; in which the Frequently Asked Question(s) context provides instructions for specific safety and hazard features of the determined vehicle type; in which the service and safety precautions context provides service bulletin and/or service safety precaution information for mechanics and vehicle repair persons; in which the video context provides previously recorded video and demonstrations of rescue or training based on the determined vehicle type; in which the training context provides links to long form training documentation; in which the community context provides access to internet community forums for rescue personnel filtered based on the determined vehicle type; and in which the accident information context provides data and telemetry information captured from a specific vehicle's Engine Control Module (ECM) or Engine Control Unit (ECU) including at least one or more of vehicle direction, vehicle speed, vehicle airbag deployment(s), vehicle restraint status(es), and vehicle sensor data.

According to another embodiment of method 400, the layered images context provides images and diagrams of the determined vehicle type that display to the user interface an outline representation of the determined vehicle type and location and type of hazard features for the determined vehicle type as a series of layered images, each of the layered images being displayable in isolation responsive to user selection and displayable in an aggregate form with one or more additional ones of the layered images responsive to the user selection at the user interface.

According to another embodiment of method 400, the location and type of hazard features are depicted via the series of layered images, each of the layered images having at least one but not all of the hazard features depicted, the layered images each depicting at least one of: a vehicle outline layer, a vehicle interior details layer, a vehicle seats layer, a vehicle electrical hazard(s) layer, a vehicle restraint hazard(s) layer, a vehicle airbag hazard(s) layer, a vehicle cut-resistant beam hazard(s) layer, and a vehicle fuel system hazard(s) layer.

In accordance with a particular embodiment, there is a non-transitory storage media having instructions stored thereon that, when executed by a processor of a system, the instructions cause the system to perform operations including: receiving vehicle identification information; querying a database based at least in part on the received vehicle identification information to determine a vehicle type; retrieving associated data based on the determined vehicle type; and presenting the associated data to a user interface and causing the user interface to display at least the determined vehicle type, a navigation menu, and at least a sub-set of the associated data retrieved based on the determined vehicle type.

FIG. 5 shows a diagrammatic representation of a computing device (e.g., a “system”) 500 in which embodiments may operate, be installed, integrated, or configured.

In accordance with one embodiment, there is a computing device 500 having at least a processor 590 and a memory 595 therein to execute implementing logic and/or instructions 596. Such a computing device 500 may execute as a stand alone computing device with communication and networking capability to other computing devices, may operate in a peer-to-peer relationship with other systems and computing devices, or may operate as a part of a hosted computing environment, such as an on-demand or cloud computing environment which may, for instance, provide services on a fee or subscription basis.

According to the depicted embodiment, computing device 500 includes a processor or processors 590 and a memory 595 to execute instructions 596 at the computing device 500. The computing device 500 further includes a display interface 550 is to present a Graphical User Interface (GUI) 598; a receive interface 526 to receive vehicle identification information 597 (e.g., as incoming data, etc.); a query interface 535 to query a database based at least in part on the received vehicle identification information 597 to determine a vehicle type 554, in which the query interface 535 is to further retrieve associated data 553 based on the determined vehicle type 554; and in which the display interface 550 to present the associated data 553 to the GUI 598, and in which the display interface 550 is to display at least the determined vehicle type (e.g., displayed vehicle type 599), to display a navigation menu (e.g., displayed navigation menu 551), and display at least a sub-set of the associated data (e.g., displayed associated data 552) retrieved based on the determined vehicle type 554.

According to another embodiment, the receive interface 526 of the computing device 500 receiving the vehicle identification information 597 constitutes one of: the receive interface 526 to receive the vehicle identification information from a police, fire, and/or emergency dispatch center (“dispatch”), in which the dispatch receives the vehicle identification information via radio or telephone and enters the vehicle identification information into a dispatch computer terminal, in which the vehicle identification information is then to be communicated from a first location to the computing device at a second location over a network; or the receive interface 526 to receive the vehicle identification information via a first responder inputs in situ at the display interface of the computing device while en route to an accident scene; or the receive interface 526 to receive the vehicle identification information via a mobile computing device, tablet, smart phone, or laptop computer having the computing device and its display interface embodied therein, wherein the mobile computing device, tablet, smart phone, or laptop computer is to receive the vehicle identification information as a user input to the display interface and transmit the vehicle identification information via the query interface to a remote system over a network for use in querying the database.

According to another embodiment of the computing device 500, each of the components of the GUI 598 provide graphical user elements that may be placed upon a screen or display of a user's device when executing the application 589 or pursuant to execution of the implementing logic or instructions 596.

According to another embodiment, the computing device 500 further includes a web-server to implement a request interface 525 to receive user inputs, selections, incoming vehicle identification information, and other data consumed by the computing device 500 so as to implement the accident scene rescue, extrication, and incident safety solution described herein.

According to another embodiment of the computing device 500, a user interface operates at a user client device remote from the computing device 500 and communicatively interfaces with the computing device 500 via a public Internet; in which the computing device 500 operates at a host organization as a cloud based service provider to the user client device; and in which the cloud based service provider hosts the application and makes the application accessible to authorized users affiliated with the customer organization.

According to another embodiment, the computing device 500 is embodied within one of a tablet computing device or a hand-held smartphone such as those depicted at FIGS. 7A and 7B.

Bus 515 interfaces the various components of the computing device 500 amongst each other, with any other peripheral(s) of the computing device 500, and with external components such as external network elements, other machines, client devices, etc., including communicating with such external devices via a network interface over a LAN, WAN, or the public Internet. Query interface 535 provides functionality to pass queries from the request interface (e.g., web-server) 525 into a database system for execution or other data stores as depicted in additional detail at FIGS. 1 and 2.

FIG. 6 depicts an exemplary graphical interface operating at a mobile, smartphone, or tablet computing device in accordance with the embodiments. In particular, there is depicted a smartphone or tablet computing device 601 having embodied therein a touch interface 605, such as a mobile display. Presented or depicted to the mobile display 605 is the navigation menu viewer 602 in which the navigable display contexts 625 are depicted and available to the user for selection or use in navigation. For instance, there are depicted here a variety of navigation contexts including a search display context, a summary display context, a components display context, a layered images display context, a training information display context, and a video display context. Other contexts may be displayed to a user via the display or may be present within the user interface but off screen, and thus, must be scrolled to, etc. Additionally depicted is the vehicle summary details 684 context from which a user may review the determined vehicle type and default summary information for the vehicle. In one embodiment, the vehicle summary details 684 are presented responsive to a successful search or inquiry to establish or determine the vehicle type. The user may then alter the display by selecting any of a variety of navigable contexts.

Other views and display contexts are also provided and accessible via the navigation menu viewer 602. For instance a Frequently Asked Questions (FAQ) context provides processes and means by which to detail with a vehicle feature or hazard of particular interest. For instance, the FAQ context may teach how to disconnect electrical, battery, airbags, and fuel systems, etc.

In another embodiment there is a FAQ and Layers display context which provides additional information with the previously described layers, such as manufacturer, model, year, body type, fuel type, body style, trim level, manufacturer's vehicle or body code, range of years for applicability of the rescue and hazard data, etc., each of which is retrievable via the search methodologies described above and then integrated into the appropriate view.

In another embodiment there is a video display context which provides, for example, captured helmet cam data obtained through actual or training rescues or an interface to upload and submit such helmet cam data. Video demonstrations may additionally be provided through this context as correlated to a determined vehicle type.

In another embodiment there is a training display context which provides, for example, links to long form training documents, which are often 100-200 pages long and thus are not appropriate for emergencies, but the training materials often do exist for rescues and hazard information and so despite its long format, does provide viable information to fire fighters and first responders for training purposes in a non-emergency situation. Some training information is also provided by firefighters themselves or non-manufacture entities, such as first responders associations, and so the training display context additionally provides this relevant information. Thus, the training display context may link to or provide information by manufacturers, municipalities, fire fighter committees, vehicle experts, mechanics, etc. This kind of information is especially helpful for newer electrified vehicle drive systems for which there may be more pertinent fire fighter derived information pertaining to such electric vehicles that is broadly applicable to many vehicles than the myriad of specific information provided by manufacturers of such vehicles.

In another embodiment there is a components display context which provides, for example, an unfiltered view of all data from any accessible resource, resulting in a huge repository of accessible data according to the determined vehicle type that could be used for training. Such data may be explored in a non-emergency context and may provide useful to firefighters and other first responders.

In another embodiment there is a community or web forum display context which provides, for example, access to pre-existing or content specific community web forums through the provided user interface (e.g., such as a touch interface 605 of a mobile display). Incorporating access to such community information within the user interface provides fast and convenient access through which a first responder may read posts and comments by others or may post questions for consideration by others. For instance, a firefighter may post a simple solution to a known problem, or collaborate with others to identify an appropriate rescue and extrication solution.

In another embodiment there is an accident information display context which provides, for example, access to telemetry data and any information accessible from a vehicle's Engine Control Module (ECM) or Engine Control Unit (ECU). This information is sometimes provided through an Over The Air (OTA) interface and may thus be retrieved from a third party's database, wherein other instances the information is accessible from the vehicle's On Board Diagnostics (OBD) data port (e.g., including for example, vehicle direction, vehicle speed, vehicle airbag deployment(s), vehicle restraint status(es), and vehicle sensor data).

FIG. 7A depicts a tablet computing device 701 and a hand-held smartphone 702 each having a circuitry integrated therein as described in accordance with the embodiments. As depicted, each of the tablet computing device 701 and the hand-held smartphone 702 include a touch interface 703 (e.g., a touchscreen or touch sensitive display) and an integrated processor 704 in accordance with disclosed embodiments.

For example, in one embodiment, a system embodies a tablet computing device 701 or a hand-held smartphone 702, in which a display unit of the system includes a touchscreen interface 703 for the tablet or the smartphone and further in which memory and an integrated circuit operating as an integrated processor are incorporated into the tablet or smartphone, in which the integrated processor implements one or more of the embodiments described herein. In one embodiment, the integrated circuit described above or the depicted integrated processor of the tablet or smartphone is an integrated silicon processor functioning as a central processing unit (CPU) and/or a Graphics Processing Unit (GPU) for a tablet computing device or a smartphone.

FIG. 7B is a block diagram 700 of an embodiment of tablet computing device, a smart phone, or other mobile device in which touchscreen interface connectors are used. Processor 710 performs the primary processing operations. Audio subsystem 720 represents hardware (e.g., audio hardware and audio circuits) and software (e.g., drivers, codecs) components associated with providing audio functions to the computing device. In one embodiment, a user interacts with the tablet computing device or smart phone by providing audio commands that are received and processed by processor 710.

Display subsystem 730 represents hardware (e.g., display devices) and software (e.g., drivers) components that provide a visual and/or tactile display for a user to interact with the tablet computing device or smart phone. Display subsystem 730 includes display interface 732, which includes the particular screen or hardware device used to provide a display to a user. In one embodiment, display subsystem 730 includes a touchscreen device that provides both output and input to a user.

I/O controller 740 represents hardware devices and software components related to interaction with a user. I/O controller 740 can operate to manage hardware that is part of audio subsystem 720 and/or display subsystem 730. Additionally, I/O controller 740 illustrates a connection point for additional devices that connect to the tablet computing device or smart phone through which a user might interact. In one embodiment, I/O controller 740 manages devices such as accelerometers, cameras, light sensors or other environmental sensors, or other hardware that can be included in the tablet computing device or smart phone. The input can be part of direct user interaction, as well as providing environmental input to the tablet computing device or smart phone.

In one embodiment, the tablet computing device or smart phone includes power management 750 that manages battery power usage, charging of the battery, and features related to power saving operation. Memory subsystem 760 includes memory devices for storing information in the tablet computing device or smart phone. Connectivity 770 includes hardware devices (e.g., wireless and/or wired connectors and communication hardware) and software components (e.g., drivers, protocol stacks) to the tablet computing device or smart phone to communicate with external devices. Cellular connectivity 772 may include, for example, wireless carriers such as GSM (global system for mobile communications), CDMA (code division multiple access), TDM (time division multiplexing), or other cellular service standards). Wireless connectivity 774 may include, for example, activity that is not cellular, such as personal area networks (e.g., Bluetooth), local area networks (e.g., WiFi), and/or wide area networks (e.g., WiMax), or other wireless communication.

Peripheral connections 780 include hardware interfaces and connectors, as well as software components (e.g., drivers, protocol stacks) to make peripheral connections as a peripheral device (“to” 782) to other computing devices, as well as have peripheral devices (“from” 784) connected to the tablet computing device or smart phone, including, for example, a “docking” connector to connect with other computing devices. Peripheral connections 780 include common or standards-based connectors, such as a Universal Serial Bus (USB) connector, DisplayPort including MiniDisplayPort (MDP), High Definition Multimedia Interface (HDMI), Firewire, etc.

FIG. 8 illustrates a diagrammatic representation of a machine 800 in the exemplary form of a computer system, in accordance with one embodiment, within which a set of instructions, for causing the machine/computer system 800 to perform any one or more of the methodologies discussed herein, may be executed. In alternative embodiments, the machine may be connected (e.g., networked) to other machines in a Local Area Network (LAN), an intranet, an extranet, or the public Internet. The machine may operate in the capacity of a server or a client machine in a client-server network environment, as a peer machine in a peer-to-peer (or distributed) network environment, as a server or series of servers within an on-demand service environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 800 includes a processor 802, a main memory 804 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 818 (e.g., a persistent storage device including hard disk drives and a persistent database), which communicate with each other via a bus 830. Main memory 804 includes an application GUI 824 to present information to a user as well as receive user inputs. Main memory 804 includes an application GUI 823 to present and display information, such as the determined vehicle type, a summary, a navigation menu, and other relevant data about a determined vehicle; main memory 804 further includes application GUI 823 to execute instructions, receive and process the vehicle identification information, to determine the vehicle type, to retrieve the associated data, and to interact with the application GUI 824 responsive to user inputs, etc.; and main memory 804 still further includes query interface 825 to query databases in accordance with the methodologies described to receive additional information for processing and display. Main memory 804 and its sub-elements are operable in conjunction with processing logic 826 and processor 802 to perform the methodologies discussed herein.

Processor 802 represents one or more general-purpose processing devices such as a microprocessor, central processing unit, or the like. More particularly, the processor 802 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 802 may also be one or more special-purpose processing devices such as an application specific integrated circuit (ASIC), a field programmable gate array (FPGA), a digital signal processor (DSP), network processor, or the like. Processor 802 is configured to execute the processing logic 826 for performing the operations and functionality which is discussed herein.

The computer system 800 may further include a network interface card 808. The computer system 800 also may include a user interface 810 (such as a video display unit, a liquid crystal display (LCD), or a cathode ray tube (CRT)), an alphanumeric input device 812 (e.g., a keyboard), a cursor control device 814 (e.g., a mouse), and a signal generation device 816 (e.g., an integrated speaker). The computer system 800 may further include peripheral device 836 (e.g., wireless or wired communication devices, memory devices, storage devices, audio processing devices, video processing devices, etc.).

The secondary memory 818 may include a non-transitory machine-readable storage medium or a non-transitory computer readable storage medium or a non-transitory machine-accessible storage medium 831 on which is stored one or more sets of instructions (e.g., software 822) embodying any one or more of the methodologies or functions described herein. The software 822 may also reside, completely or at least partially, within the main memory 804 and/or within the processor 802 during execution thereof by the computer system 800, the main memory 804 and the processor 802 also constituting machine-readable storage media. The software 822 may further be transmitted or received over a network 820 via the network interface card 808.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as are apparent to those skilled in the art. Therefore, the scope of the appended claims are to be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A computer-implemented method to execute within a system having at least a processor and a memory therein, wherein the computer-implemented method comprises:
receiving vehicle identification information;
querying a database based at least in part on the received vehicle identification information to determine a vehicle type;
retrieving associated data based on the determined vehicle type; and
presenting the associated data to a user interface and causing the user interface to display at least the determined vehicle type, a navigation menu, and at least a sub-set of the associated data retrieved based on the determined vehicle type.

2. The computer-implemented method of claim 1, wherein receiving the vehicle identification information comprises one of:
receiving the vehicle identification information from a police, fire, and/or emergency dispatch center (“dispatch”), wherein the dispatch receives the vehicle identification information via radio or telephone and enters the vehicle identification information into a dispatch computer terminal for transmission to the system, the system receiving the vehicle information from the dispatch computer terminal;
receiving the vehicle identification information via a first responder's in situ computing device en route to an accident scene;
receiving the vehicle identification information via a mobile computing device, tablet, smart phone, or laptop computer having the user interface displayed thereupon, wherein the mobile computing device, tablet, smart phone, or laptop computer receives the vehicle identification information as a user input and transmits the vehicle identification information to the system for use in querying the database; and
receiving the vehicle identification information from a first computing device, communicating the vehicle identification information to the system over a network, and communicating the associated data for presentment to the user interface to a third computing device over the network.

3. The computer-implemented method of claim 1:
wherein receiving the vehicle identification information comprises receiving license plate and licensing authority data as the vehicle identification information;
wherein the method further comprises querying a second database, distinct from the first database, wherein querying the second database comprises specifying the license plate and licensing authority data as part of a search query to the second database and receiving a Vehicle Identification Number (VIN) or a VIN range responsive to the querying of the second database; and
wherein querying the first database based at least in part on the received vehicle identification information to determine a vehicle type comprises querying the first database based at least in part on the received VIN or the VIN range received from the second database.

4. The computer-implemented method of claim 3:
wherein the second database comprises a third party database operating as a cloud based service and accessible to the system over a public Internet network;
wherein the first database comprises a locally connected database accessible to the system via a Local Area Network;
wherein receiving the vehicle identification information comprises receiving an alphanumeric string corresponding to an automobile license plate and licensing authority;
wherein querying the second database comprises querying the third party database operating as the cloud based service via an Application Programming Interface (API) into which the alphanumeric string corresponding to the automobile license plate and licensing authority is entered as input;
wherein querying the database based at least in part on the received vehicle identification information comprises specifying the alphanumeric string corresponding to the automobile license plate and licensing authority as an input into the API and receiving the VIN or VIN range in return; and
wherein querying the first database comprises querying the locally connected database specifying the VIN or a VIN compatible string derived from the VIN or VIN range to determine the vehicle type.

5. The computer-implemented method of claim 3:
wherein querying the first database based at least in part on the received VIN or the VIN range received from the second database comprises:
querying the second database specifying the received VIN when the VIN is received and querying the second database specifying a synthesized VIN when the VIN range is received;
receiving the vehicle type responsive to querying the second database; and
wherein the synthesized VIN comprises an individual VIN compatible string derived from the VIN range, wherein the VIN range corresponds to a plurality of theoretical individual VINs and is incompatible with a standardized VIN format.

6. The computer-implemented method of claim 3, further comprising:
querying a third database, distinct from the first and second databases;
wherein querying the third database comprises specifying the determined vehicle type; and
receiving the associated data from the third database responsive to querying the third database.

7. The computer-implemented method of claim 1:
wherein receiving the vehicle identification information comprises one of:
receiving a Vehicle Identification Number (VIN);
receiving an alphanumeric string corresponding to a vehicle license plate string and associated state, province, or country having licensing authority for the license plate string;
receiving an image of the vehicle license plate and extracting the alphanumeric string corresponding to the vehicle license plate from the image;
receiving a partial vehicle license plate and wildcarding a missing portion of the partial vehicle license plate;
receiving a search string having therein free form text or key word search text; and
receiving user input at the user interface specifying the vehicle identification information from a graphical gallery view of available vehicle types.

8. The computer-implemented method of claim 1:
wherein the determined vehicle type comprises a unique vehicle identifier (vehicle ID), the unique vehicle ID corresponding to at least a year, make, and model, and optionally specifying one or more of manufacturer vehicle code, chassis code, fuel type, trim level, engine type, and drive train.

9. The computer-implemented method of claim 1:
wherein retrieving the associated comprises receiving, based on the determined vehicle type, one or more of:
vehicle rescue cards;
vehicle Frequently Asked Questions (FAQs);
vehicle foils, layers, and/or laminar images, each depicting vehicle components;
vehicle hazard layers;
vehicle video demonstrations;
vehicle rescue training information;
vehicle safety data;
vehicle telemetry data;
vehicle web forum data;
vehicle schematics;
vehicle parts lists;
vehicle photographs;
vehicle diagrams;
vehicle cut points and non-cut points for emergency passenger extrication from a wrecked vehicle; and
vehicle de-electrification instructions for a hybrid electric vehicle and non-cut points specific to the hybrid electric vehicle.

10. The computer-implemented method of claim 1, wherein presenting the associated data to a user interface comprises presenting the associated data to a Graphical User Interface (GUI) at a client device communicably interfaced to the system, wherein presenting to the GUI includes presenting a graphical navigational menu at the GUI of the client device and presenting a summary based on the determined vehicle type to the GUI, the summary having been retrieved as the sub-portion of the associated data retrieved.

11. The computer-implemented method of claim 1, wherein presenting the associated data to a user interface comprises presenting a summary of vehicle key rescue details based on the associated data retrieved, the summary of vehicle key rescue details including on a single screen of the user interface a one or more of: engine type, quantity of airbags, types of airbags, locations of airbags, fuel shut off device location, fuel capacity, break resistant glass locations, quantity of batteries and battery types, battery voltages, battery chemistry, quantity of restraints and restraint types, and cut resistant door beams and locations.

12. The computer-implemented method of claim 10, further comprising:
receiving user input at the GUI responsive to a user initiated event at the graphical navigational menu and responsively navigating the GUI to a new graphical context based on the user input, and presenting at the GUI a different sub-portion of the associated data retrieved based on the new graphical context navigated to based on the user input.

13. The computer-implemented method of claim 1, wherein the navigation menu comprises a graphical navigational menu displayed within a Graphical User Interface, the graphical navigational menu having navigational elements including at least two or more of:
a search context;
a summary context;
a components context;
a layered images context;
a Frequently Asked Question(s) context;
a service and safety precautions context;
a video context;
a training context;
a community context; and
an accident information context.

14. The computer-implemented method of claim 13:
wherein the search context provides a search interface through which to input any of a license plate, a VIN, a free form text or search parameter inquiry, or gallery input search;
wherein the summary context provides summary information as a default single screen at a Graphical User Interface (GUI) responsive to a successful search result input to the search context;
wherein the components context provides additional detailed information about the determined vehicle type in a filterable view;
wherein the layered images context provides images and diagrams of the determined vehicle type including internal features and hazard features on a plurality of distinct image layers;
wherein the Frequently Asked Question(s) context provides instructions for specific safety and hazard features of the determined vehicle type;
wherein the service and safety precautions context provides service bulletin and/or service safety precaution information for mechanics and vehicle repair persons;
wherein the video context provides previously recorded video and demonstrations of rescue or training based on the determined vehicle type;
wherein the training context provides links to long form training documentation;
wherein the community context provides access to internet community forums for rescue personnel filtered based on the determined vehicle type; and
wherein the accident information context provides data and telemetry information captured from a specific vehicle's Engine Control Module (ECM) or Engine Control Unit (ECU) including at least one or more of vehicle direction, vehicle speed, vehicle airbag deployment(s), vehicle restraint status(es), and vehicle sensor data.

15. The computer-implemented method of claim 13:
wherein the layered images context provides images and diagrams of the determined vehicle type that display to the user interface an outline representation of the determined vehicle type and location and type of hazard features for the determined vehicle type as a series of layered images, each of the layered images being displayable in isolation responsive to user selection and displayable in an aggregate form with one or more additional ones of the layered images responsive to the user selection at the user interface.

16. The computer-implemented method of claim 15, wherein the location and type of hazard features are depicted via the series of layered images, each of the layered images having at least one but not all of the hazard features depicted, the layered images each depicting at least one of: a vehicle outline layer, a vehicle interior details layer, a vehicle seats layer, a vehicle electrical hazard(s) layer, a vehicle restraint hazard(s) layer, a vehicle airbag hazard(s) layer, a vehicle cut-resistant beam hazard(s) layer, and a vehicle fuel system hazard(s) layer.

17. Non-transitory computer readable storage media having instructions stored thereon that, when executed by a processor of a system, the instructions cause the system to perform operations comprising:
receiving vehicle identification information;
querying a database based at least in part on the received vehicle identification information to determine a vehicle type;
retrieving associated data based on the determined vehicle type; and
presenting the associated data to a user interface and causing the user interface to display at least the determined vehicle type, a navigation menu, and at least a sub-set of the associated data retrieved based on the determined vehicle type.

18. The non-transitory computer readable storage media of claim 17, wherein receiving the vehicle identification information comprises one of:
receiving the vehicle identification information from a police, fire, and/or emergency dispatch center (“dispatch”), wherein the dispatch receives the vehicle identification information via radio or telephone and enters the vehicle identification information into a dispatch computer terminal for transmission over a network to the system;
receiving the vehicle identification information via a first responder's in situ computing device en route to an accident scene;
receiving the vehicle identification information via a mobile computing device, tablet, smart phone, or laptop computer having the user interface displayed thereupon, wherein the mobile computing device, tablet, smart phone, or laptop computer receives the vehicle identification information as a user input and transmits the vehicle identification information to the system for use in querying the database; and
receiving the vehicle identification information from a first computing device, communicating the vehicle identification information to the system over a network, and communicating the associated data for presentment to the user interface to a third computing device over the network.

19. A computing device, comprising:
a processor and a memory to execute instructions at the computing device;
a display interface to present a Graphical User Interface (GUI);
a receive interface to receive vehicle identification information;
a query interface to query a database based at least in part on the received vehicle identification information to determine a vehicle type;
the query interface to further retrieve associated data based on the determined vehicle type; and
the display interface to present the associated data to the GUI, wherein the display interface is to display at least the determined vehicle type, a navigation menu, and at least a sub-set of the associated data retrieved based on the determined vehicle type.

20. The computing device of claim 19, wherein the receive interface to receive the vehicle identification information comprises one of:
the receive interface to receive the vehicle identification information from a police, fire, and/or emergency dispatch center (“dispatch”), wherein the dispatch receives the vehicle identification information via radio or telephone and enters the vehicle identification information into a dispatch computer terminal, in which the vehicle identification information is then to be communicated from a first location to the computing device at a second location over a network;
the receive interface to receive the vehicle identification information via a first responder inputs in situ at the display interface of the computing device while en route to an accident scene;
the receive interface to receive the vehicle identification information via a mobile computing device, tablet, smart phone, or laptop computer having the computing device and its display interface embodied therein, wherein the mobile computing device, tablet, smart phone, or laptop computer is to receive the vehicle identification information as a user input to the display interface and transmit the vehicle identification information via the query interface to a remote system over a network for use in querying the database.
